(19) United States
(12) Patent Application Publication
(10) Pub. No.: US 2014/0177940 A1
(43) Pub. Date: Jun. 26, 2014

(54) RECIPE GENERATION APPARATUS, INSPECTION SUPPORT APPARATUS, INSPECTION SYSTEM, AND RECORDING MEDIA

(71) Applicants: Ryo Nakagaki, Tokyo (JP); Yuichi Hamamura, Tokyo (JP); Yuji Enomoto, Tokyo (JP); Yutaka Tandai, Tokyo (JP); Tsunehiro Sakai, Tokyo (JP); Kazuhisa Hasumi, Tokyo (JP)

(72) Inventors: Ryo Nakagaki, Tokyo (JP); Yuichi Hamamura, Tokyo (JP); Yuji Enomoto, Tokyo (JP); Yutaka Tandai, Tokyo (JP); Tsunehiro Sakai, Tokyo (JP); Kazuhisa Hasumi, Tokyo (JP)

(73) Assignee: HITACHI HIGH-TECHNOLOGIES CORPORATION, Tokyo (JP)

(21) Appl. No.: 14/236,887

(22) PCT Filed: May 28, 2011
(86) PCT No.: PCT/JP2012/003448

§ 371 Date: Feb. 3, 2014

(30) Foreign Application Priority Data
Aug. 3, 2011 (JP) 2011-169736

(51) Int. Cl. G06T 7/00; G06F 17/50

(52) U.S. Cl. CPC G06T 7/0006; G06F 17/5081
USPC 382/149

(57) ABSTRACT

A desired area is extracted by directly analyzing information recorded in a design layout, an inspection recipe is generated by using this extraction method, and an efficient inspection is realized. The invention makes it easy to extract an area of a desired circuit module such as a memory mat by analyzing hierarchy information of design layout data, calculating reference frequency of each one cell in the design layout data that is its internal data, sorting the cells in order of increasing reference frequency, searching the object, and tracing its upper cell.

### TECHNICAL FIELD

The present invention relates to a method for, at the time of inspection, measurement, or reviewing a defect of a sample on which a pattern is formed, setting an inspection area, a measurement area, or a reviewing area, an apparatus used for setting the area, or an inspection apparatus or measurement apparatus having a function of executing the setting method of the above-mentioned inspection area.

Moreover, the present invention relates to a recipe generation apparatus for generating an inspection recipe, measurement recipe, or defective reviewing recipe that includes the above-mentioned area setting process in its generation process, or a program used by the recipe generation apparatus, or a recording medium in which the program is stored.

### BACKGROUND ART

Conventionally, a main cause of yield loss in a semiconductor wafer manufacturing was particles generated at random on a semiconductor wafer, and it was able to maintain the yield by reducing these particles. However, as microfabrication of the semiconductor device proceeds into a finer stage in recent years, a ratio of defects that depend on the design layout has been increasing.

The layout-dependent defects are called systematic defects. For example, a defect that arises in association with narrowing of a process margin in lithography is called a hot spot. Moreover, a defect may arise in a boundary of a memory part and other areas in the design layout. A pattern density becomes uneven easily in the above-mentioned boundary part, such unevenness causes abnormalities to occur in manufacturing processes of the semiconductor device such as lithography, CMP, and etching, and consequently a defect is generated. Such a defect is called a mat end defect.

In order to reduce these defects, inspection has been conducted with defect inspection apparatuses such as of dark field and bright field optical types or an electron beam type in manufacturing. However, with a progress of pattern microfabrication in recent years, cases where a minute defect is overlooked with the optical defect inspection apparatus because of a limit of its resolution have increased. On the other hand, in the electron beam system, although its resolution satisfies the requirement, an inspectable area per unit time is limited, and there was a problem that neither an entire wafer surface nor an entire chip surface could be inspected within a practical time.

Therefore, in these days, a technique of intensively inspecting defects whose occurrence places can be predicted to some extent such as the above-mentioned mat end defect with a high-resolution electron beam with respect to its occurrence places has been adopted.

Moreover, regarding the hot spot, it is generally practiced that based on a result of lithography simulation, an occurrence place of a pattern whose exposure margin is narrow is predicted to some extent, and such a predicted place is put under one-dimensional or two-dimensional shape evaluation using the high-resolution electron beam.

What becomes a problem here is how to manage to perform specification of the place to be inspected by the electron beam and setting of inspection conditions at that time in a short time and simply. Although coordinate information of the hot spot can be obtained from the result of the lithography simulation, in the case of the mat end defect, it is necessary to acquire position information of a memory area end in some form or other. As an approach against this problem, specifying the inspection area such as a memory area and a logic area using design layout information of the pattern has been conceived for a long time, and some techniques have been reported.

For example, in Patent Literature 1, in order to extract a specific area from the design layout data, there is disclosed an invention whereby a label such as an identifier, a color, a numerical value, or a name is given in advance to a specific data set on the design layout data.

Moreover, in Patent Literature 2, there is disclosed an invention whereby a specific structure that becomes an inspection object is extracted from the design layout data by extracting a periodical structure using a mathematical technique such as a Fourier analysis from the design layout data including an industry standard format such as GDSII and OASIS, and mapping information of the obtained periodical structure on a layout synthesized from the design layout data.

Furthermore, in Patent Literature 3, there is disclosed an invention in which a layout pattern is divided into structural units of functional modules such as a cell part and a non-cell part by dividing the design layout data into a lattice shape, calculating a pattern density for each lattice, and grouping areas having comparable pattern densities. The divided area is set as an area to be inspected (in description of Patent Literature 3, a partial inspection area).

### CITATION LIST

### Patent Literature

Patent Literature 1: U.S. Pat. No. 6,483,937
Patent Literature 2: Japanese Unexamined Patent Application Publication (Translation of PCT Application) No. 2005-514774 (U.S. Pat. No. 6,886,153)
Patent Literature 3: Japanese Unexamined Patent Application Publication No. 2002-323458 (U.S. Pat. No. 7,231,079)

### SUMMARY OF INVENTION

### Technical Problem

As shown in the above-mentioned Patent Literatures 1 to 3, in inspection or measurement, it is extremely important how a place where the inspection or measurement should be performed is set. However, it is not so easy to relate an actual physical pattern that becomes an inspection object to design layout data.

For example, in the invention described in Patent Literature 1, a preparation work of giving a label to a specific data set on the design layout data occurs, but there is no disclosure as to how to execute this work or how to automate it at all. Moreover, although information of the given labels needs to be complied into a database, since it has become common that a data size of the design data are in an order exceeding tens of gigabytes, a man power to process the data becomes huge and a need of preparing a storage device of a huge capacity arises by saving the processed data separately. Furthermore, there are many cases where a general data format of the design layout data does not contain a portion for storing an identifier etc. that foresees the inspection in a manufacturing process, and there arises a need to manage a correspondence between the design layout data and the labels as another file.

Moreover, in the case of an invention of analyzing a periodical structure of the design layout data with a mathematical technique such as a Fourier analysis, like a description of Patent Literature 2, when a large number of circuit blocks of different functions are mounted on a single chip like a multifunctional semiconductor device having been developed recently, there is a problem that its layout becomes complex and it is difficult to specify the periodical structure efficiently and accurately.

In the case of an invention described in Patent Literature 3, there is a problem that pattern density calculation of a layout pattern requires a huge time. Recently, since the layout patterns of the semiconductor devices and flat panel displays have become highly integrated rapidly, it is difficult to perform area setting by the pattern density calculation within a practical time. Moreover, since if the density is the same, the areas will be judged to be the same area in terms of function and structure, there is a case where a discrepancy between a pattern actually formed on the sample and an area boundary occurs, and consequently the area setting is not performed correctly.

Furthermore, as a fundamental problem, there did not exist a tool for specifying a target pattern that becomes the inspection object from a structural analysis result of the design layout data, and therefore, various structural analysis techniques of the design layout data described in the above-mentioned Patent Literatures could not be utilized effectively.

Then, an object of the present invention is to provide a method and an apparatus that can realize extraction of a desired area from the design layout data at higher speed than before.

Moreover, as another object of the present invention, it aims to provide a tool capable of associating information of the hierarchical structure of the design layout data obtained by various analysis methods and the target pattern that becomes the inspection object.

Furthermore, it aims to provide a recipe generation apparatus that carries the above-mentioned fast extraction function or the above-mentioned tool, and further an inspection system, an observation system, or a measurement system in which the inspection apparatus, an observation apparatus, or a measurement apparatus is combined with the recipe generation apparatus.

### Solution to Problem

The present invention is characterized in a point that hierarchy information of the pattern is read from the design layout data of the pattern that becomes an object of the inspection, observation, or measurement, and an object area is set based on the hierarchy information. To be specific, the present invention is characterized in that a reference relationship between the cells or the functional areas contained in the pattern is analyzed from the design layout data, and the object area is specified based on the result.

Moreover, the present invention is characterized by having a user interface that can compare information of the hierarchical structure of the design layout data acquired by various analysis techniques and a pattern obtained by image-developing the design layout data, and can associate each hierarchical level of the above-mentioned hierarchical structure and the pattern.

### Advantageous Effects of Invention

According to the present invention, it becomes possible to extract the object area of desired inspection, observation, or measurement directly from the design layout data and at higher speed than before. A time required for arithmetic processing is shorter than the conventional method because an extraction principle is simple, and therefore it becomes possible to perform recipe generation in a shorter time than before and simply.

Moreover, according to the present invention, since the tool that associates the analysis result of the hierarchical structure of the design layout data and the layout pattern is provided, it becomes possible to simply set the object area of the desired inspection, observation, or measurement.

### BRIEF DESCRIPTION OF DRAWINGS

FIG. 1 is a diagram showing an arrangement of cells formed on a semiconductor wafer.

FIG. 2 is an explanatory diagram of a general cell hierarchical structure described by design layout data.

FIG. 3 is a diagram showing an arrangement of a recipe generation apparatus of a first embodiment and various apparatuses connected to the recipe generation apparatus.

FIG. 4 is a flowchart showing a recipe generation procedure using the recipe generation apparatus of the first embodiment an inspection execution procedure in an inspection apparatus.

FIG. 5 is a diagram showing an analysis result of the cell hierarchical structure.

FIG. 6 is a supplementary diagram for explaining a setup procedure of an inspection area of the first embodiment.

FIG. 7 is a diagram showing a variation of inspection area setting within a target pattern in the memory mat.

FIG. 8 is a diagram showing a variation of a selection method of a chip that is an inspection object.

FIG. 9 is one example of a GUI screen of the recipe generation apparatus of the first embodiment.

FIG. 10 is an outline diagram of mat end inspection of a second embodiment.

FIG. 11 is a diagram showing an arrangement of an inspection support apparatus of a third embodiment and various apparatuses connected to the inspection support apparatus.

FIG. 12 is a flowchart showing execution steps of a program that is executed in the inspection support apparatus.

### DESCRIPTION OF EMBODIMENTS

### First Embodiment

In this embodiment, an embodiment of a recipe generation apparatus for executing processing of extracting a peripheral area of the memory mat (hereinafter, referred to a mat end) in patterns formed on a semiconductor wafer as an inspection area will be described. Hereinafter, this embodiment will be explained referring to drawings.

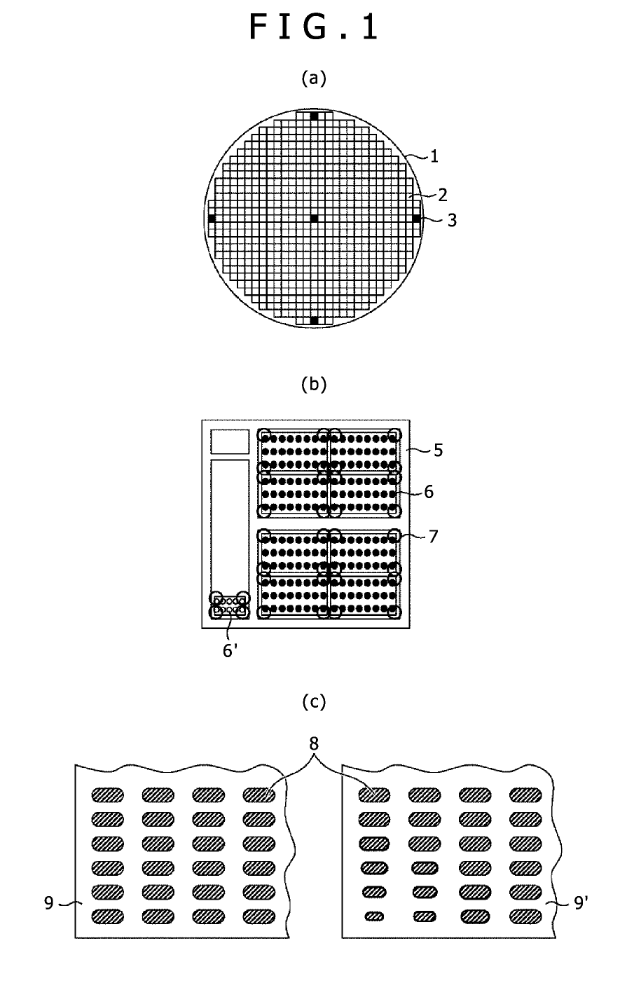

First, an outline of mat end inspection will be explained using FIG. 1. FIG. 1 (a) schematically shows an appearance of chips 2 are arranged on a wafer 1 that is an inspection object. In the inspection, there is a case where all the chips on the wafer 1 become the inspection objects, and there is also a case where an extraction inspection that specifies an inspection chip 3 is performed.

FIG. 1 (b) shows a design layout 5 of the chip 2. On the design, the design layout of the inspection chip 3 is the same as that of the chip 2. FIG. 1 (b) shows a chip of a structure where eight memory mats A6 and one memory mat B6′ are mounted on a single chip. Round frames shown near four corner parts (corners) of the memory mats A6 and B6′ show mat ends 7, and the mat inspection described above is one that inspects these mat ends 7. However, a definition of the mat end is not limited to FIG. 1 (b), but there are various specification methods.

FIG. 1 (c) shows one example of an image obtained by the mat end inspection. A left-hand side portion of FIG. 1 (c) shows a mat end inspection image 9 of a conforming article, and a right-hand side portion of FIG. 1 (c) shows a mat end inspection image 9′ of a non-conforming article. In the mat end inspection image 9′ of the non-conforming article, the patterns are not formed uniformly and the pattern becomes small-sized as the pattern approaches the corner of the memory mat. The inspection is performed by performing tripartite comparison of multiple mat end inspection images 9. Alternatively, a defective pattern can be detected by: preparing the mat end inspection images 9 of the conforming article; or performing bipartite comparison of an image of a layout pattern obtained by image-developing design layout data or an image of a pattern obtained by performing exposure simulation on the layout pattern and the mat end inspection image. The object of the mat end inspection may be not only memory products that are represented by DRAM, SRAM, and flush memory but also a system LSI in which these circuits are incorporated. What was described above is the mat end inspection generally performed, but it is not necessarily limited to the above. Incidentally, in a subsequent explanation, “layout pattern” shall mean a pattern obtained by image-developing the design layout data, or an image of the pattern.

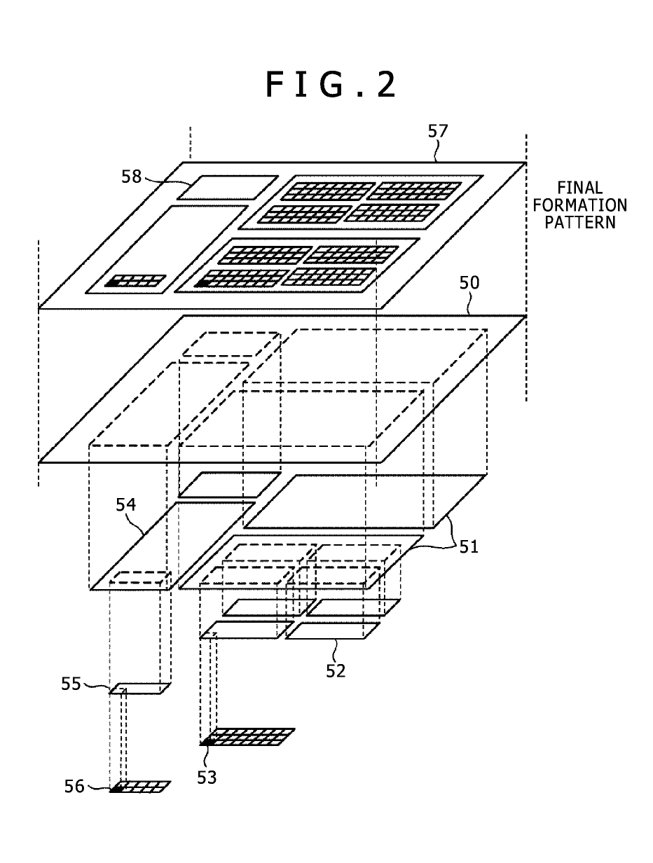

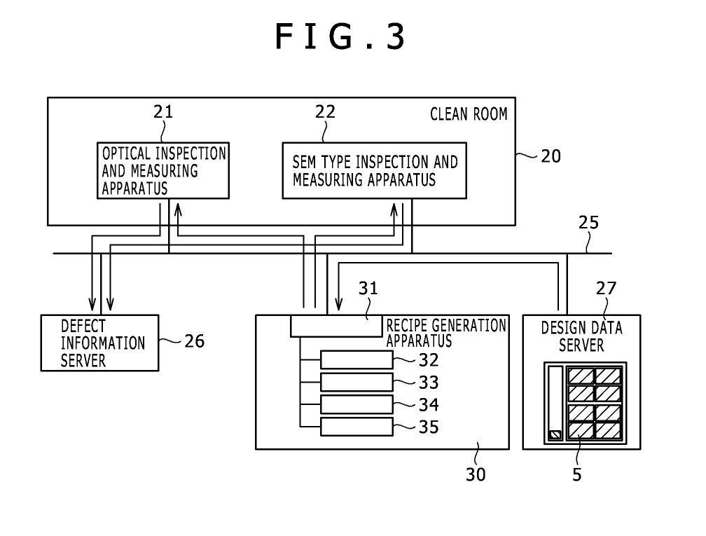

Next, a cell hierarchical structure of the design layout of a semiconductor and a layer structure of the semiconductor device will be briefly explained using FIG. 2 and FIG. 3.

Generally, the design layout data of the semiconductor device has a hierarchical structure, and is described using abase unit called a cell. Here, the cell is an aggregation of pieces of pattern data repeatedly used in the design layout data of an integrated circuit, or an aggregation of pieces of pattern data that is logically or functionally meaningful. It can also be handled as a new cell by naming an aggregate of multiple cells possible as data. Moreover, designating the pattern data that is functionally meaningful as a cell, a pattern corresponding to such a cell constitutes a functional area having a certain function on the chip layout.

In order to explain the cell hierarchical structure of the general design layout, FIG. 2 shows a pattern obtained by image-developing the cell in each hierarchical level hierarchically. The pattern information of the one whole chip is stored in a root cell that is in an uppermost level of the hierarchical structure, and when the whole root cell is image-developed, a pattern as represented by a pattern 57 is obtained. As a cell one level lower in the hierarchy of this root cell, a cell A corresponding to a pattern 50 equivalent to a frame of an outermost periphery of the pattern 57 is arranged.

In the design layout data, the data structure is defined so as to hold such a hierarchical structure between the cells. First, for the root cell of the layout, a name of each cell and link information to a cell one level lower in the hierarchy that the cell contains are stored. Then, regarding the cell in its lower hierarchical level, its name and link information to a cell in a further one-stage lower hierarchical level are stored similarly. Such a relationship between the cells is further applied to a further lower hierarchical level repeatedly, and information about all the cells in the layout is stored.

Therefore, if a link relationship between the cells that are included in the data is investigated so as to utilize such a structure of the design layout data and their reference frequencies are counted, the hierarchical relationship and the number of hierarchical levels of the cell can be detected.

An actual pattern is generated using multiple masks created based on the design layout by means of an exposure process (resist application→exposure using mask→development). Incidentally, when the pattern corresponding to each cell is formed, there is a case where multiple photomasks are used, and conversely there is also a case where a pattern corresponding to multiple cells is formed with a single photomask. Therefore, the hierarchical structure of the design layout data may differ from a physical layer structure of a semiconductor device that is actually manufactured using the design layout data.

Thus, the design data is defined by the hierarchical structure that uses a lowermost cell as a unit, and that the lower cell is referred to by an upper cell enables a complex pattern to be described. In a subsequent explanation, a cell in an upper hierarchical level to a certain cell may be called a parent cell, and cells in lower hierarchical levels may be called a child cell and a grandchild cell.

Next, a method for generating an inspection recipe of setting a memory mat end of the semiconductor device as the inspection area using the hierarchical structure of the design layout data explained in FIG. 2 will be explained. In this example, although the design layout is simplified considerably, since integration has been progressed in actual semiconductors, they are of complex structures. In order to perform recipe setting simply even in the complex structure, a method that uses a reference frequency and upper cell tracing will be described below.

FIG. 3 shows an arrangement of the recipe generation apparatus of this embodiment and various apparatuses connected to the recipe generation apparatus. A manufacturing process of the semiconductor device is processed in a clean room 20 usually maintained in a clean environment. In the clean room 20, optical or SEM type inspection apparatuses such as an optical inspection and measuring apparatus 21 and an SEM type inspection and measuring apparatus 22 that inspect defects of a product wafer are installed. These two apparatuses may be installed.

The optical inspection and measuring apparatus 21 includes a dark field defect inspection apparatus and a bright field defect inspection apparatus both for defect inspection, a scatterometry type measuring apparatus for measuring pattern dimensions, etc. On the other hand, the SEM type inspection and measuring apparatus 22 includes an electron beam defect inspection apparatus for defect inspection, a defective review SEM capable of inspecting defects and acquiring a high-resolution SEM image of detected defects, a length measurement SEM for pattern dimension measurement, etc. Acquired data of these optical inspection and measuring apparatus 21 and SEM type inspection and measuring apparatus 22 is transferred to a defect information server 26 connected therewith through a communication network 25 and is saved.

In order to generate the recipe used in the optical inspection and measuring apparatus 21 and the SEM type inspection and measuring apparatus 22, a recipe generation apparatus 30 is arranged, is connected with the communication network 25, and is configured to be able to transmit the generated recipe. The recipe generation apparatus 30 has a function of generating the recipe using the design layout data, and is connected with a design data server 27 in which the design layout data of the inspection object is saved through the communication network 25. Although it is desirable that the design layout data used for the recipe setting is in industry standard formats such as GDS-II and OASIS, it is not necessarily limited to this. Incidentally, although giving and receiving of the data shown in FIG. 1 is based on transfer via the communication network, it is also possible to perform it via a recording medium such as a hard disk drive and a memory stick.

The recipe generation apparatus 30 is comprised of a workstation, a personal computer, etc., and has a function of supporting generation of the recipes used in the optical inspection and measuring apparatus 21 and the SEM type inspection and measuring apparatus 22. To be specific, the recipe generation apparatus 30 includes: a network interface 31 for giving and receiving data with other apparatuses and servers; a storage device 32 for storing necessary information such as the design layout data, the already generated recipe, and a recipe generation program; a processor 33 for executing arithmetic processing required in order to realize a function of the recipe generation apparatus 30; memory 34 in which a program used in the processor 33, a table becoming necessary in the arithmetic processing, etc. are stored; user interfaces 35 such as a display for displaying the design layout 5 and a GUI (Graphical User Interface) by which the user inputs instruction contents, a keyboard, and a pointing device (mouse etc.) for operating the GUI; and the like. As processing performed by the processor 33, there are, for example, graphic transformation for enabling the design layout data acquired from the design data server 27 to be read, display processing of the design layout according to the user's demand, analysis processing of the cell hierarchical structure of the design layout data, etc.

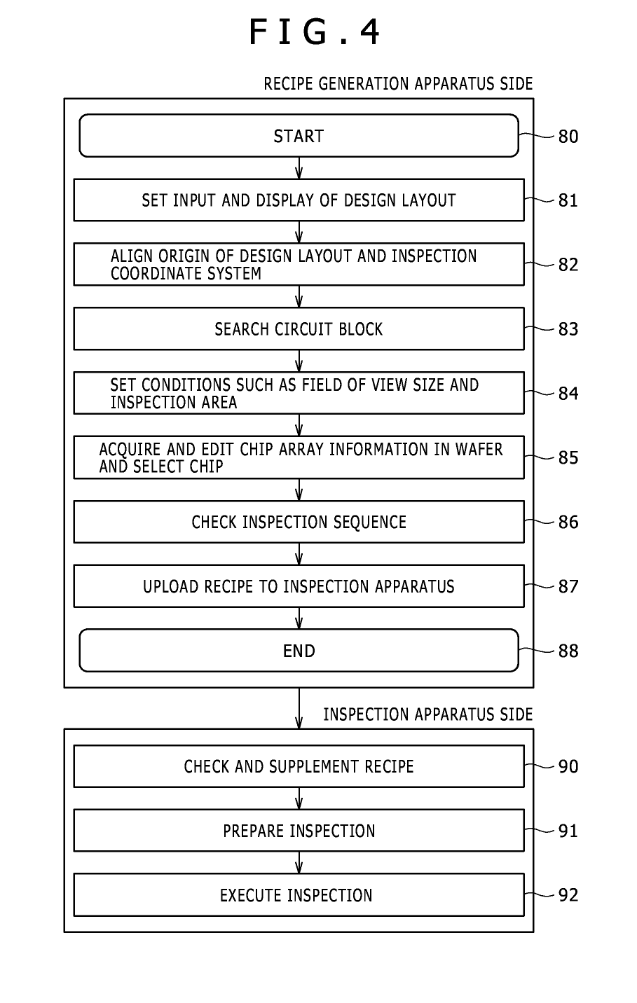

Next, using FIG. 4, a procedure in which the recipe generation apparatus 30 sends a recipe to the inspection apparatus (a general term of the optical inspection and measuring apparatus 21 and the SEM type inspection and measuring apparatus 22) and the inspection is executed will be explained.

FIG. 4 is a flowchart of recipe generation to inspection execution, in which steps 81 to 87 correspond processing on the recipe generation apparatus side and steps 90 to 92 correspond to processing on the inspection apparatus side.

In step 80, the recipe generation apparatus 30 is in a waiting state for an instruction of an apparatus operator to start recipe generation processing, and recipe generation processing is started by the apparatus operator inputting the start as a trigger.

When recipe generation processing start is started, first, the processor 33 starts reading of the design layout data and stores it in the storage device 32. At this time, the processor 33 shall acquire in advance information of the object physical layer on which the inspection is performed following an instruction of the apparatus user such as an operation of the GUI, and shall read only the design layout data related to formation of the layer. At the same time, processing of drawing the layout pattern by image-developing the design layout data is executed, and the layout pattern is displayed on the display (step 81). This makes a state of capable of setting the recipe on the design layout data.

Next, the processor 33 executes origin alignment processing of the coordinate system in the design layout 5 and the inspection apparatus (step 82). Since in the inspection apparatus, there are many cases where a lower left corner of the chip is set to the origin whereas in the design layout, there are frequently cases where a center of the chip is set to the origin, in order to align the coordinate systems of the both, origin alignment is performed by registering the origin used by the inspection apparatus in the design layout. When the origin used by the inspection apparatus has been already known, this origin alignment processing is executed by the processor 33 reading numerical values stored in the storage device 32 or the memory 34; when the above-mentioned origin has not been known, the apparatus operator performs the setting through the GUI screen.

Next, a target pattern that is designated as the inspection object is searched by analyzing the design layout data (step 83), and condition setting of a size of a field of view (FOV), the inspection area, etc. is performed using this result (step 84). Extraction processing of the mat end of this embodiment is performed in this step 83.

In the condition setting in step 84, for example, in the case of an inspection using an electron beam, it is also possible to appropriately set various settings of not only the filed view size and the inspection area but also a beam current, an acceleration voltage, a scan speed, the number of times of frame addition, existence/absence of auto focus, existence/absence of addressing, various setting accompanying these, etc.

Next, acquisition or creation of chip array information in the wafer and chip selection are performed (step 85). Chip selection 85 may be performed before a search 83 of a circuit block.

In step 86, confirmation processing of an inspection sequence that is preliminarily decided is performed and a checking work as to whether the inspection area is set correctly is performed. This work can be done by the apparatus operator by performing a slide show presentation of a pattern of each cell on the layout pattern and checking it visually. Moreover, since a presumed time of the inspection is displayed on the GUI, it can be checked whether the time required for the inspection is too long. After the checking, when the apparatus operator clicks a transmission button displayed on the GUI, upload processing of the generated recipe to the inspection apparatus is executed (step 87).

Next, a procedure on the inspection apparatus side will be described. First, checking of the recipe that has been sent and supplement 90 are performed if needed. If the inspection is possible only with a sent recipe, the supplement will be unnecessary, but if there is lacking information, it will be supplemented suitably and registered. Next, inspection preparation 91 such as beam adjustment and alignment of the sample is performed. After the preparation has been completed, an actual inspection is performed based on the recipe (step 92).

Next, details of the analysis processing of the design layout data performed by the recipe generation apparatus 30 and setting processing of the inspection area based on the analysis processing will be explained.

When a processing step of the flowchart shown in FIG. 4 transits to step 84, the processor 33 contained in the recipe generation apparatus 30 reads the design layout data stored in the storage device 32, and starts the analysis processing of the cell hierarchical structure of the design data.

Specifically, the processor 33 executes processing of analyzing the structure of the design layout data by repeating processing of: reading data of the design layout described in various kinds of formats such as GDSII and OASIS; specifying data corresponding to the root cell; searching data linked from the root cell; determining whether the link destination is a cell; incrementing the count value by unity if it is a cell; and searching a further link destination of the data of the link destination. According to the above procedure, processing of counting the referring cells (or to-be-referred cells) of the cells arranged in each hierarchical level is performed.

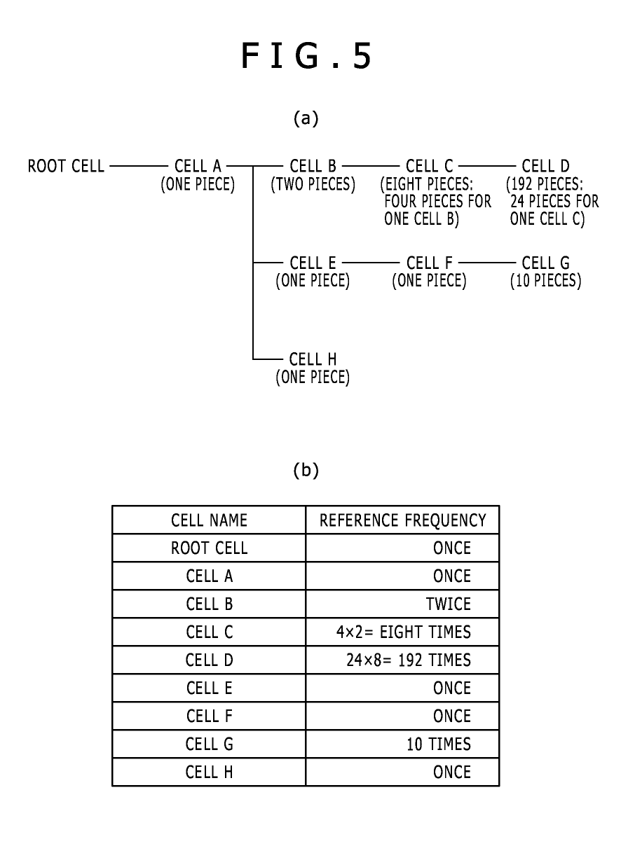

FIG. 5 shows a result that the design layout data of the hierarchical structure shown in FIG. 2 is analyzed by the above-mentioned procedure. FIG. 5 (a) represents the cell hierarchical structure that has become clear in a tree form. A left end of the figure corresponds to the root cell and a cell located in its lower hierarchical level is described as the position goes to the right of the figure. The relationship between the cells is as described above.

FIG. 5 (b) is a table showing a relationship between a cell name of each hierarchy and the number of times that the cell is used, i.e., the reference frequency. The cells enumerated here are listed in the left column, and each reference frequency is displayed on its right-hand side. A point to notice is the reference frequencies of a cell C and a cell D. Although the cell C is referred to four times for one cell B that is in its higher hierarchical level, since in the root cell, the cell B is referred to twice and the cell A that is an upper cell of the cell B is referred to once, its total reference frequency in the whole becomes eight times that is a multiplication result of them. Similarly, since the cell D is referred to 24 times for one cell B and the cell B is referred to eight times, its total reference frequency in the whole becomes 192 times that is a multiplication result of them.

Now, although the hierarchical structure itself of the design layout data can be analyzed by the above arithmetic processing, it is still unknown in which hierarchy the target pattern that is designated as the inspection object, measurement, or observation exists. What is necessary to associate the target pattern and the cell is to perform association with a cell located somewhere in the cell hierarchy and a pattern corresponding to this as at least one example or more and trace the cell hierarchy until the target pattern is reached using the cell that has been successfully associated as a starting point.

Therefore, in this embodiment, the target pattern and the target cell are associated by the above-mentioned analysis result being displayed on the GUI of the recipe generation apparatus 30 and by the apparatus operator checking visually the cell hierarchical structure obtained by the analysis and specifying a hierarchical level of the target pattern or the target cell, The above-mentioned GUI is displayed on the display of which the recipe generation apparatus 30 is comprised.

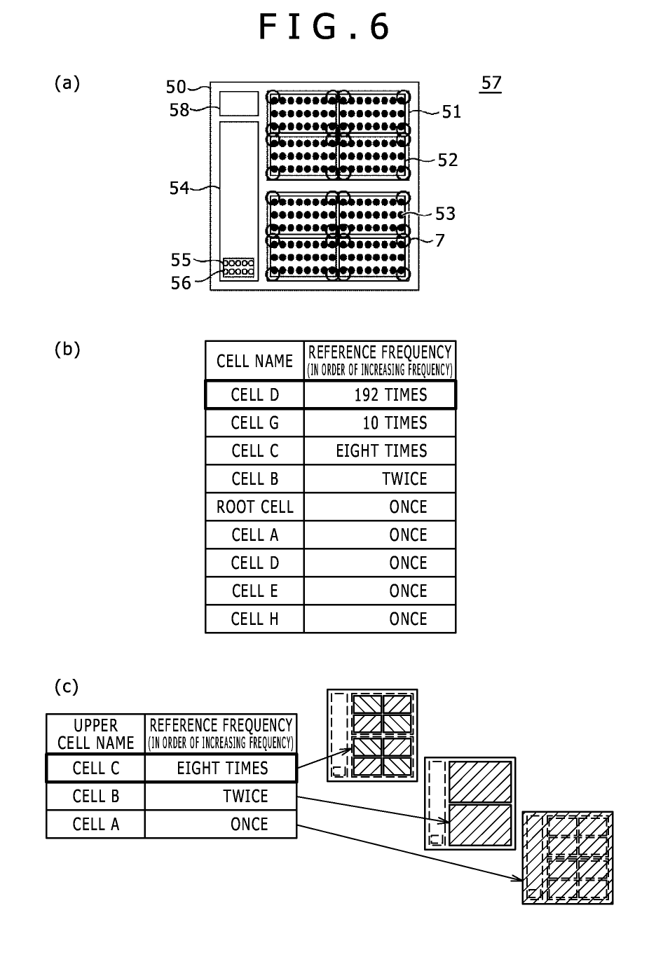

Below, a procedure for specifying the mat end that is the inspection object of this embodiment using the analysis result of the design layout data will be explained using FIG. 6. A hierarchical tree shown in FIG. 5 (a) and a table shown in FIG. 5 (b) indicate that the lowermost cell is the cell D, a cell having a largest reference frequency is the cell D, and the cell D is a grandchild cell of the cell B, i.e., is contained in the system of the cell B. Moreover, the reference frequency of the cell B seen from the root cell is twice.

FIG. 6 (a) is a diagram showing a layout pattern containing an inspection object area. In this embodiment, the target pattern is an end of the memory mat area shown by solid dots in FIG. 6 (a), and an area surrounded by round frames in FIG. 6 (a) corresponds to an area that should be inspected. Incidentally, although a size of a memory cell is smaller than this in the actual memory mat and a large number of memory cells are usually contained in the inspection area, the cells are illustrated with their numbers reduced from that of the actual semiconductor device in FIG. 6 (a) in order to make it consistent with FIG. 2 and FIG. 5.

FIG. 6 (b) shows a table obtained by rearranging (sorting) the table shown in FIG. 5 (b) in order of increasing reference frequency of the cell. As described above, a cell having the largest reference frequency is the cell D being referred to 192 times, and is contained in a system of the cell B. On the other hand, a cell G exists in the tree shown in FIG. 5 (a) as another lowest cell and there also exists a possibility that the tree of the cell E containing the cell G is a system that contains a cell corresponding to the target pattern (since a cell H does not have its internal structure, it is eliminated as a candidate of the target pattern).

Here, comparing the hierarchical tree shown in FIG. 5 (a), the layout pattern shown in FIG. 6 (a), and the sorted table shown in FIG. 6 (b), respectively, first it is understood that there exists only the cell A as a cell that is arranged in a hierarchical level directly below the root cell, is unity in number, and contains all the other cells. Therefore, it is understood that a pattern corresponding to the cell A is the pattern 50.

Next, paying attention to the number of the lowermost cells, the number of the cells D that are the lowermost cells of the cell B is 192, and the number of the cells G that are the lowermost cells of the cell D is 10. Therefore, comparing these cells with the layout pattern of FIG. 6 (a), it is understood that a pattern corresponding to the cell D is a pattern 53, and a pattern corresponding to the cell G is a pattern 56. Since it is self-explanatory that the pattern 53 is the memory cell in the memory mat area by checking visually the layout pattern, it is understood that the memory mat being the target pattern is arranged in one cell hierarchy of a tree that connects the cell D to the cell A.

According to the hierarchical tree shown in FIG. 5 (a), the cell D exists on the system of the cell B branching from the cell A. Therefore, if the target pattern is traced from the upper cell side starting from the cell B as the origin or the target pattern is traced from the lower cell side starting from the cell D as the origin on the layout pattern of FIG. 6 (a), the cell corresponding to the memory mat that is the inspection object can be extracted. From which side the tracing is performed should be determined by selecting a side from which the target pattern can be reached faster. Since the memory mat is considered a structure body at most several levels higher than the memory cell (one hierarchical level or two hierarchical levels), the tracing is performed from the side of the pattern 53, i.e., from the side of the cell D in this embodiment.

FIG. 6 (c) shows a situation where the upper cell of the cell D is traced one level by one level and these cells are represented as the layout pattern. For emphasis, the pattern corresponding to the cell in each hierarchical level is displayed shaded. In the figure, a table in which the reference frequency of the upper cell on the tree to which the cell D belongs is represented again after extracting it from an analysis result of the cell structure shown in FIG. 5 is also shown collectively. The reference frequency of the cell B in the first level is eight times, and this is a number that coincides with the number of times that a pattern 52 appears on the layout pattern.

On the other hand, when the layout pattern is referred to, it turns out that the pattern 52 contains the pattern 53 that is the memory cell and acts as a pattern that directly refers to the cell D, and therefore the pattern 52, i.e., the cell C, corresponds to the memory mat that is the target pattern. Here, both of the cell B (i.e., a pattern 51) and the cell A (i.e., the pattern 50) refer to cells other than the memory cell on the layout pattern, and therefore these patterns 50, 51 do not correspond to the memory mat.

The association processing between the cell and the pattern that was explained above is executed by the followings: the information expressed by FIG. 5 (a), FIG. 6 (a), and FIG. 6 (b) (or information represented by FIG. 5 (a), FIG. 6 (a), and FIG. 6 (b)) is displayed on the GUI of the recipe generation apparatus; a pattern corresponding to each cell is made to be highlighted on the layout pattern by the GUI operation; and the operator checks association between the cell and the pattern visually while the cells to be highlighted are changed one by one. As a method of highlighting, there are conceivable, for example, a method of displaying a pattern border line with a thick line, a method of displaying it with a color changed from that of a background of the screen, or a method of filling it with diagonal lines as shown in FIG. 6 (c).

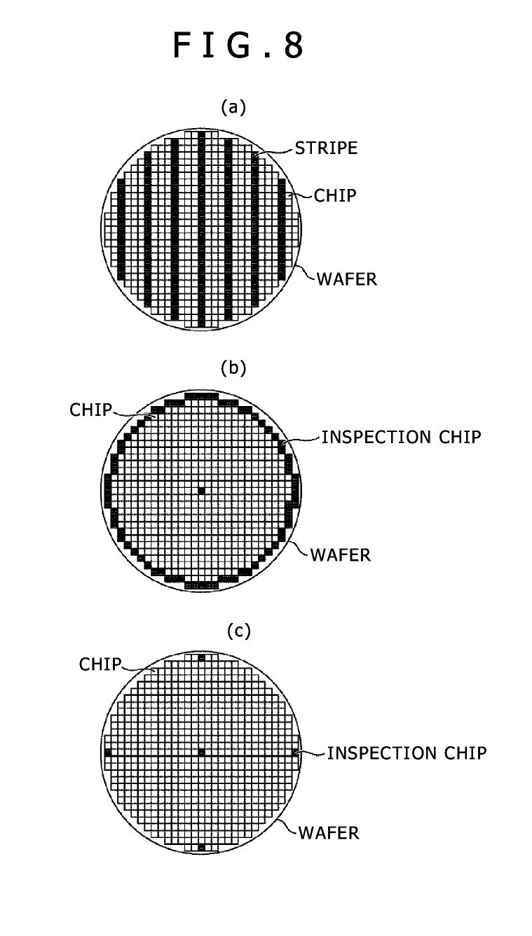

In order to execute the above highlighting processing, the memory 34 included in the recipe generation apparatus of this embodiment stores a program of performing highlighting of a pattern that the operator specified in the whole layout pattern and a pattern that is in a relationship of referring to and being referred from the pattern, and the above-mentioned display function is realized by the processor 33 executing this program. After the cell corresponding to the target pattern becomes clear, the desired area of the pattern corresponding to the cell is specified on the GUI, and is sets as a final inspection area. The above work is done through the GUI shown in FIG. 8 (a) that will be described later.

Incidentally, although the target cell was traced from the lowest level of the cell hierarchy in the explanation using the above FIG. 6, it goes without saying that even if the tracing is started from the uppermost level, i.e., the cell in the hierarchical level directly under the root cell, the inspection area can be set. Moreover, when the cell hierarchy is complex, it is also possible to set an appropriate middle hierarchical level cell between the lowermost cell and the uppermost cell, and to perform the tracing of a cell from this middle hierarchical level cell as the origin.

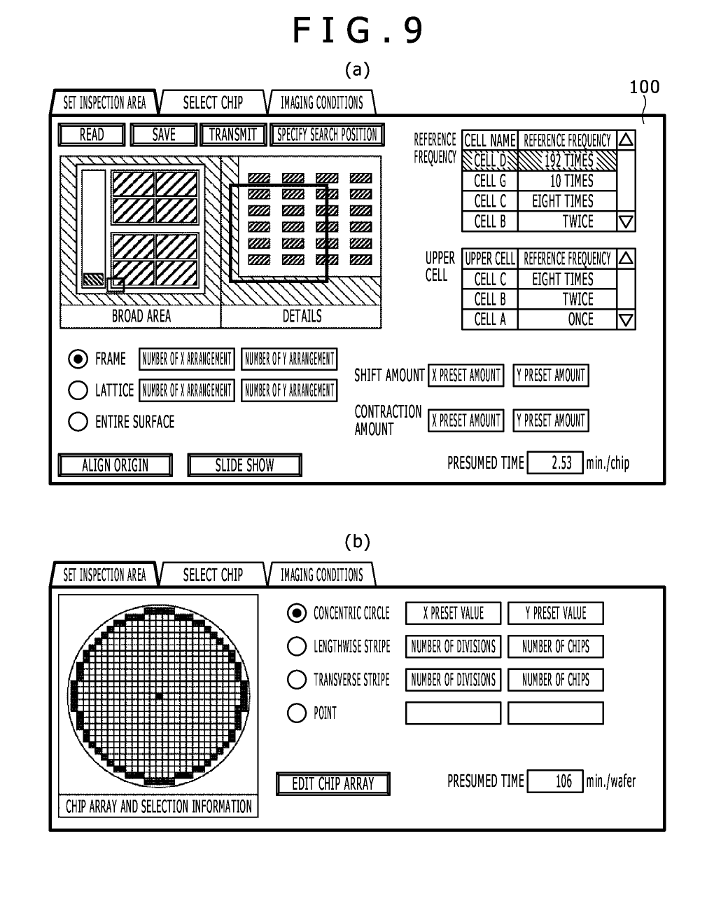

After the object cell is specified, it is specified which portion within the target pattern is designated as the inspection area of the mat end inspection. How to specify the mat end varies depending on the kind of a chip and the manufacturing process of the device, area specification of the mat end becomes necessary according to the kind of inspection. The apparatus operator performs area specification within the target pattern through the GUI shown in the below-mentioned FIG. 9. An imaging field of view (FOV: Field Of View) of a suitable size is specified in the inspection area within the above-mentioned target pattern thus specified, and an image of the above-mentioned area is picked up. A size of the FOV may change according to inspection conditions and an imaging capability of the inspection apparatus, and there are a case where the specified area can be imaged one time and a case where several times of imaging is required. Incidentally, in a subsequent explanation, the inspection area specified within the target pattern is called an “inspection area within the target pattern.”

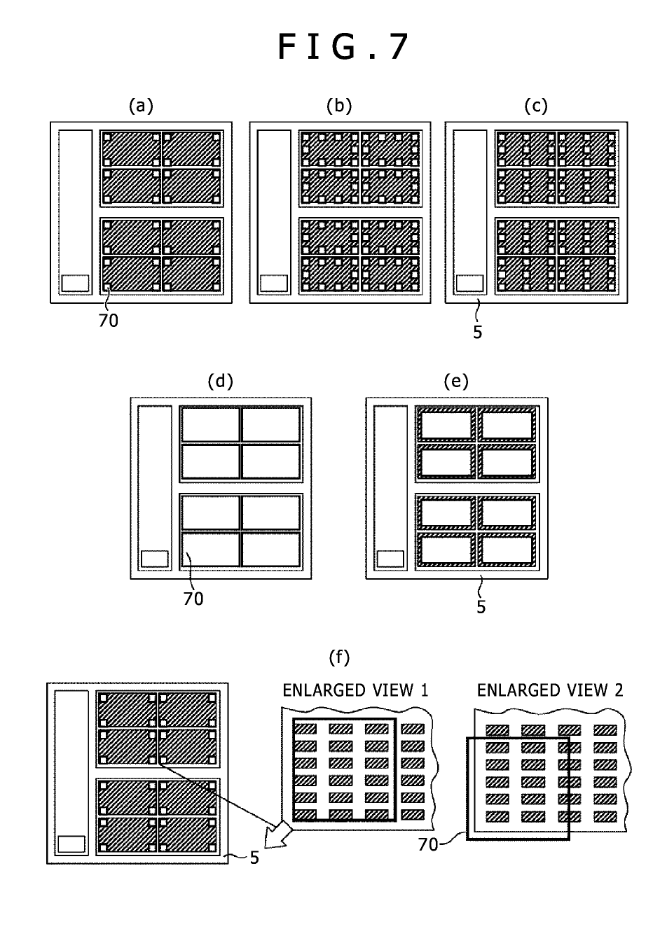

FIG. 7 shows the variation of the area specification of the mat end.

FIG. 7 (a) shows an example where the inspection areas within the target pattern are specified at four corners of the memory mat end. A square frame in the figure is an inspection area 70 within the target pattern. In this example, a size of the inspection area within the target pattern is set to be the same as a FOV size. Moreover, the design layout data has position information of the cell from a suitable origin as internal information. Therefore, in this example, if information as to which cell is one that coincides with the memory mat (pattern 52) that is the target pattern and size information of the FOV are known, the coordinates at which the FOV should be arranged can be computed automatically and set from the position information of the cell and the FOV size.

FIG. 7 (b) shows a case where the inspection area 70 within the target pattern shown by a rectangular frame is specified so as to surround the mat in a frame shape in addition to the four corners of the mat end. Since the information includes not only the information of the four corners of the mat, it is possible to perform finer completion management.

FIG. 7 (c) shows a case where the inspection area 70 within the target pattern shown by the rectangular frame is specified in a lattice shape to the mat. Since the information also includes information of a center of the mat, it is effective in comparing the completion. FIGS. 7 (b) and (c) can be set up automatically if the numbers of FOV arrangement in lengthwise and transverse directions are specified for reach one of the target patterns.

FIG. 7 (d) shows a case where the inspection area 70 within the target pattern shown by the rectangular frame is set up automatically so that it surrounds the entire mat. In this example, since the size of the inspection area within the target pattern and the FOV size are not in agreement, the memory mat will be imaged with multiple FOVs arranged in the mat, or in a continuous movement method of the stage.

FIG. 7 (e) shows an example where area setting is performed by contracting the size of the inspection area within the target pattern being set in FIG. 7 (d) inwardly by a distance defined in advance. Once the information of the cell and the contraction amount are set, automatic setting can be done also in this example. Here, FIGS. 7 (d) and (e) show the recipes effective in a scan inspection, i.e., bright field type and dark field optical inspections, or SEM type visual inspection.

FIG. 7 (f) describes a method of shifting the inspection area being set in FIG. 7 (a). This is because if the inspection area is set up so as to be very close to the mat end, there is a possibility that the pattern cannot be housed in the FOV in the case where stop accuracy of the stage is not sufficient when the stage is moved for the SEM type defect review or for dimension measurement. An enlarged view 1 shows an arrangement of the inspection area within the target pattern and an enlarged view 2 shows an arrangement of the inspection area within the target pattern in a state where it is shifted to the outside of the mat end, respectively. The automatic setting will be possible also in this example if the shift amount is set in advance.

Incidentally, a function of the above explained automatic setting is realized by the processor 33 included in the recipe generation apparatus 30 executing a program stored in the memory 34.

After specifying a detailed inspection area of the mat end inspection, chips to be inspected in the wafer are selected. FIGS. 8 (a), (b), and (c) show types of chip selection system in the wafer. FIG. 8 (a) shows the inspection chips arranged on multiple lines of lengthwise stripes. The stripes can be set automatically by setting a start chip of the stripe, a selection width, and a pitch of non-selection. FIG. 8 (b) shows the inspection chips arranged concentrically with a line of the chips specified along an outer circumference of the wafer and one chip specified in a center of the wafer. The chip selection system of FIG. 8 (b) is effective for evaluation of completion of an in-plane distribution of the wafer and especially the wafer outer circumference that is expected to be in bad completion. FIG. 8 (c) shows an example where total five places of four places in the wafer outer circumference and one place in the center of the wafer are set manually.

In order to conduct these settings, since arrangement information of all the chips in the wafer is required in advance, it is necessary to acquire the information in advance or create it in advance if there is no information.

A user screen 100 is shown in FIG. 9 as one example of the GUI displayed on the display that accompanies the recipe generation apparatus 30 of this embodiment. After the analysis processing of the design layout data explained in step 83 of FIG. 4 is completed, the apparatus operator performs various kinds of operations calling the GUI shown in FIG. 9 (a), and performs the setting processing of the inspection area corresponding to step 84 of FIG. 4.

In the GUI of this embodiment, a setup screen for setting up various inspection conditions is displayed with tabs, and in the case of setting the inspection area based on the cell hierarchy analysis, the setup screen shown in FIG. 9 (a) can be called by clicking an “set inspection area” tab.

Functions of buttons and windows displayed on the user screen shown in FIG. 9 (a) are as described below.

On clicking of a read button, a read operation of the design layout data and an already registered recipe is performed. On clicking of a save button, a save operation of an edited recipe is performed. On clicking of a transmit button, upload recipe processing to the inspection apparatus is performed. A specify search position button is a button for searching a cell, and on clicking of the button, only a cell existing in a specified position is searched. A “broad area” window is a wide area displaying screen of the layout pattern, and a “detail” window is a screen for giving a zoom display of a part of the layout pattern displayed in the broad area window. In a “reference frequency” window, pieces of data in which the cells whose reference frequencies are counted are listed in order of increasing reference frequency are displayed, irrespective of the tree. In an “upper cell” window, a result of extracting the reference frequency of the upper cell to a specified arbitrary cell is displayed. On the right-hand side of the “reference frequency” window and the “upper cell” window, a scroll bar is displayed and when the number of displayed cells is large, the displayed cell can be changed by operating the scroll bar.

A frame button is a button used when arranging the FOV of the inspection image in a border portion of the target pattern such as the memory mat and a peripheral area. When a numerical value of 2 is inputted into each box of “number of X arrangement” and “number of Y arrangement” on the right-hand side of the frame button and the frame button is clicked, the FOVs equal to the setting number are arranged at equal intervals in the border portion of the target pattern.

Similarly, a “lattice button” is a button used when arranging the FOV of the inspection image inside the target pattern. When the number of FOV arrangement into the inside of the target pattern is inputted into each box of “number of X arrangement” and “number of Y arrangement” on the right-hand side of the lattice button and the lattice button is clicked, the FOVs equal to the setting number are arranged at equal intervals inside the pattern containing the target pattern border. On clicking of an entire surface button, all the areas inside the target pattern are set as the inspection areas.

A “shift amount” button is a button used when shifting arrangement of the FOV from a pattern end by a fixed quantity. When a suitable numerical value is inputted into each box of “X preset amount” and “Y preset amount” on the right-hand side of the shift amount button and the shift amount button is clicked, the FOVs equal to the setting number are arranged at equal intervals inside the pattern containing the target pattern border.

A “contraction amount” button is a button used when reducing the inspection area a little from a visible outline of the target pattern on the design data, For example, in the case where the target pattern is the memory mat, when a suitable numerical value is inputted into each box of “X preset amount” and “Y preset amount” on the right-hand side of the contraction amount button and the contraction amount button is clicked, an area that is contracted toward the inside by the contraction amount being set from the boundary of the memory mat on the design data is set as the inspection area. This button is used mainly when the whole target pattern surface is set as the inspection (or measurement, observation) area.

On clicking of an “align origin” button, the origin alignment processing between the layout pattern and the inspection coordinate system is executed. Moreover, on clicking of a “slide show” button, the confirmation processing of the inspection area specified by the recipe is executed. In a “presumed time” box, a time required for inspection per chip under the inspection conditions being set up is displayed.

FIG. 9 (b) shows one example of the GUI screen for selecting the chip in the wafer explained in FIG. 7. A “chip array and selection information” window is a screen for displaying a chip array on the wafer, and the chip that is to be inspected is selected by operating the pointing device on this screen. Alternatively, an array of the selected chips on the wafer is checked. A “edit chip array” button is a button for turning on/off an edit function of the chip array on the wafer, and with this button activated, when each button of “concentric circle,” “lengthwise stripe,” “transverse stripe,” “checkered pattern,” and “point” located on the upper part is operated, an operation result will be reflected in chip selection. Moreover, on inactivation of the “edit chip array” button, the array of the selected chips that is effective now is fixed.

Each button of “concentric circle,” “lengthwise stripe,” and “transverse stripe” displayed above the “edit chip array” button shows an array pattern of the chips that is included in the recipe generation apparatus of this embodiment by default, and is used as a tool for lightening a burden of a chip selection work.

When a suitable numerical value is inputted to each box of “X preset value” and “Y preset value” on the right-hand side of a “concentric circle” button and the “concentric circle” button is clicked, the chips located away from the outermost periphery chips of the wafer by “X preset value” and “Y preset value” are set as the inspection chips concentrically.

In the case of the “lengthwise stripe”, when a suitable numerical value is inputted into each box of “number of divisions” and “number of chips” on the right-hand side of the button and the each button is clicked, chip arrays of the stripe shape in the lengthwise direction as shown in FIG. 7 (a) are set in intervals obtained by dividing the number of chips in the wafer transverse direction by the “number of divisions.” At this time, the number of chips included in the stripe is set according to the “number of chips” being set. A maximum preset value of the number of chips is the number of chips existing on the diameter of the wafer. Since the shape of the wafer is circular, when the preset value of the number of chips is set to the maximum preset value, the stripe that passes except the center of the wafer will not be able to have the number of chips equal to the preset value. Therefore, for the stripe that passes except the center of the wafer, the maximum number of chips in an arrangement place of the stripe is set as the number of constitutional chips of the stripe. Regarding the “transverse stripe”, the longitudinal direction of the stripe only changes from lengthwise to horizontal, and functions of boxes of “number of divisions” and “number of chips” are the same as those of the “lengthwise stripe.”

A “point” button is a button for specifying the inspection object chip, one chip by one chip, arbitrarily on the wafer, and when a pointer operation is performed on the “chip array and selection information” window with this button activated and a desired chip is clicked, the chip can be specified as the inspection object chip. Multiple target chips can be specified, and when specifying the inspection object chip at random or in other cases, setting is performed using this button. When the “point” button is inactivated with the specified chip being in an effective state, a setting state is saved and will be reflected in the inspection recipe. In the “presumed time” box, a time required for inspection per wafer is displayed.

All the functions realized by respective buttons or windows explained above are realized by the processor 33 executing a screen display processing program stored in the memory 34. The processor 33 reads the operator's instruction by the clicking of the button or the numerical value inputted into the box, and executes a function corresponding to each button and image display processing into the window.

As described, the recipe generation apparatus of this embodiment becomes able to realize searching of a circuit module that is designated as the inspection object such as the memory mat, and area setting on the recipe by virtue of a new feature that a reference relationship between the cells is found by analyzing the hierarchical structure of the design layout data and counting the reference frequency of the cell within the design layout data.

Moreover, since it is possible to perform the recipe generation that depends only on the design layout data, a recipe generation work can be performed being detached from apparatuses in the clean room such as the inspection apparatus, a measurement apparatus, or an observation apparatus. Therefore, the apparatuses in the clean room are not occupied for the recipe setting, availability of the inspection apparatus can be improved, and capital investment of a production line can be suppressed. Furthermore, it is possible to detect a systematic defect that poses a problem in fine devices in recent years by carrying out an inspection work efficiently and effectively, and consequently it becomes possible to promptly raise the yield at the time of a development, a trial production, and a mass production of the semiconductor device.

### Second Embodiment

The first embodiment explained the inspection area setting method of specifying the cell corresponding to the target pattern by specifying the lowermost cell or the uppermost cell about a specific tree of the cell hierarchical structure, and tracing the specific tree from the lowermost cell side or the uppermost cell side.

Such an inspection area setting method is extremely effective when repeatability of the pattern in the chip is high, for example, when the memory mat occupies almost the entire chip layout. However, in areas where the repeatability is low such as a circumference circuit and a logic circuit, a probability that a pattern corresponding to the uppermost cell or the lowermost cell is an already known pattern is low and it is difficult to specify a tree that certainly contains the target pattern.

Therefore, in this embodiment, a setting technique of the inspection area whereby an arbitrary pattern on the layout pattern or an arbitrary cell on the cell hierarchical tree is selected, a tree passing through the selected cell is extracted, and only the extracted tree is designated as a tracing object will be explained. Incidentally, although the configuration and rough operations of the recipe setting apparatus of this embodiment are the same as those of the first embodiment and their detailed explanations are omitted, regarding their explanations, the description of the first embodiment is quoted suitably.

Now, let it assumed that the apparatus is driven along the flowchart shown in FIG. 4 and the analysis result of the cell hierarchical structure shown in FIG. 5 is obtained, and the inspection object area in this embodiment is the mat end of the memory mat B6′ on the chip layout shown in FIG. 1 (b).

Considering a case where correspondence between the pattern contained in the memory mat B and the cell is not known at all, it is difficult to judge on which tree the cell containing the memory mat B6′ lies from the entire tree shown in FIG. 5 (a). When the target pattern is traced from the root cell, there are two cells, the cell E and the cell H, as the cells having the same reference frequency of once under the cell A, and it is not known in which tree the target pattern is contained. Conversely, if tracing it from the lowermost cell side is tried, it will be difficult to specify the cell only with the reference frequency unless the number of memory cells contained in the memory mat B6′ is known.

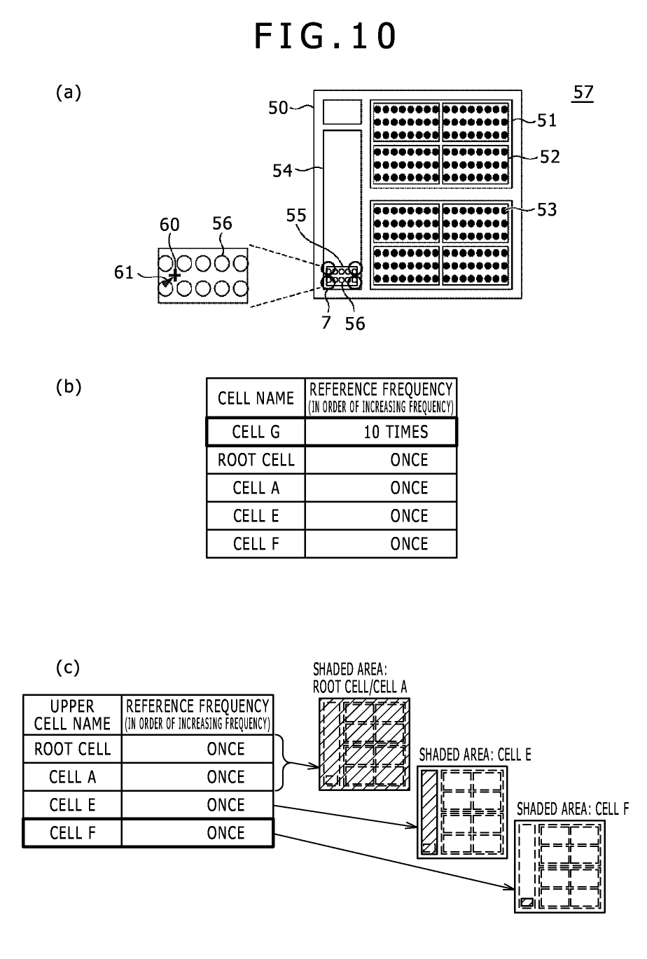

Therefore, in this embodiment, the layout pattern is made to be displayed on the GUI, the pointing device is enabled to specify a specific area, and a tree of the cell that passes through the specified area is extracted from the entire tree. Below, the above operation will be explained using FIG. 10.

FIG. 10 (a) is a general view showing the layout pattern displayed in the “broad area” window of the GUI shown in FIG. 8 (a). The left-hand side portion of the layout pattern general view shows an enlarged view of the memory mat B. When the apparatus operator performs a work in step 84 of FIG. 4, the operator operates a pointer 60 on the layout pattern displayed in the “detail” window of the GUI shown in FIG. 8 (a), and specifies an arbitrary point in the memory mat B, i.e., a pattern 55, for example, the search position 60.

When the search position 60 is specified, the recipe generation apparatus 30 reanalyzes the design layout data and extracts the cell in which the search position 60 is contained. Since the design layout data has the position information of the cell from an appropriate origin as internal information, it is possible to extract only the cell that passes through the specified search position 60 by the processor 33 executing a program for performing the analysis processing of the position information of the cell contained in the design layout data stored in the memory 34.

FIG. 10 (b) shows a list of cells that are extracted by position information analysis of the cells and that passed through the search position 60. In this list, the cells that pass through the search position are sorted and shown in order of increasing reference frequency. The cell having the largest reference frequency is the cell G, and the frequency is 10 times. Therefore, the cell G can be presumed to be a lowermost cell of the hierarchical tree that passes through the search position.

Once the lowermost cell is decided, what is necessary after this is to decide the target pattern by trial and error like the first embodiment. FIG. 10 (c) shows images of a process of the trial and error displayed on the GUI. This figure shows a situation where the upper cell of the cell G is traced one level by one level, and the reference frequency of each upper cell is listed again. Since the reference frequency of any cell is once, drawing the layout sequentially starting from a root cell 57, it turns out that neither the cell A nor the cell E that are in the lower hierarchical level of the root cell fits to the target pattern, and the cell F in the further lower hierarchical level coincides with the target pattern (a shaded area of the cell F of FIG. 10 (a)). Therefore, it turns out that the cell F is the object cell.

Although in the above explanation, the inspection area setting method for extracting the tree containing the target pattern by specifying the search position, the search position can be specified as an area not only by specifying the search position at a pin point but also by surrounding a certain area by the pointer operation.

As described above, according to this embodiment, it is possible to realize a very effective recipe setting apparatus or inspection support apparatus when setting the inspection area of a pattern with a low repeatability. It goes without saying that the area setting method of this embodiment can be applied not only to so-called visual inspection but also to the defective review apparatus or the dimension measurement apparatus.

### Third Embodiment

This embodiment explains an apparatus of a configuration such that the analysis function of the design layout data explained in the first and second embodiments is set to be independent from the recipe generation apparatus as a different unit (an inspection support apparatus).

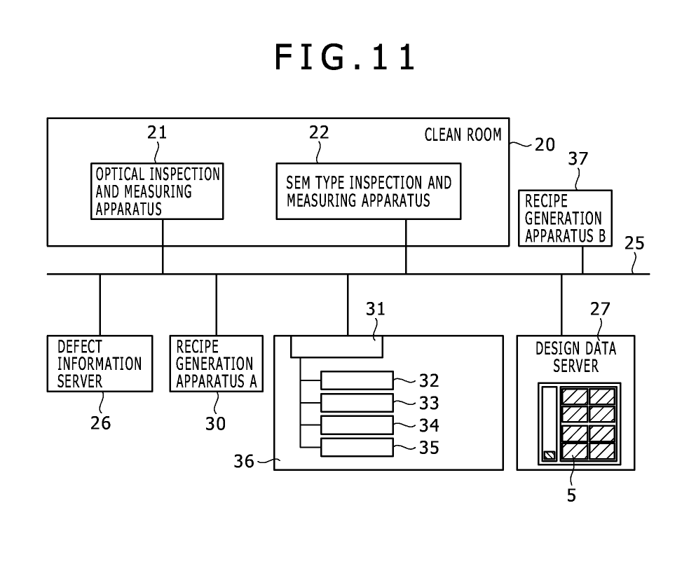

FIG. 11 shows an arrangement of the inspection support apparatus of this embodiment and various apparatuses connected to the inspection support apparatus. A configuration of this embodiment is the same as the configuration shown in FIG. 3 in respects that various apparatuses such as the defect information server 26 and the design data server 27 are connected with the optical inspection and measuring apparatus 21 or the SEM type inspection and measuring apparatus 22 installed in the clean room 20 through the communication network 25. However, the case of this embodiment differs from the arrangement of FIG. 3 in the following respects: the network interface 31, the storage device 32, the processor 33, the memory 34, the user interface 35, etc. that were incorporated in the recipe generation apparatus 30 in the first and second embodiments are incorporated in an inspection support apparatus 36 that is separate from the recipe generation apparatus 30; and as the recipe generation apparatuses, two sets of a recipe generation apparatus A for the optical inspection and measuring apparatus and a recipe generation apparatus B for the SEM type inspection and measuring apparatus are provided.

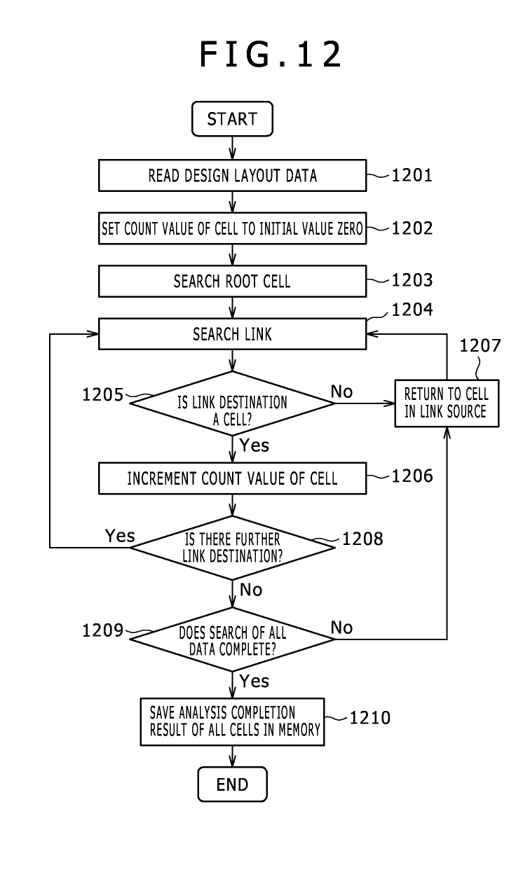

FIG. 12 shows processing that the processor 33 performs at the time of a structural analysis of the design layout data in the inspection support apparatus 36 of this embodiment with a flowchart.

When the apparatus operator instructs start of the analysis of the design layout data through the GUI etc., first the processor 33 reads the design layout data (step 1201), and next sets a value of the counter for counting the cells to an initial value zero (step 1202). Next, the processor 33 analyzes the data program of the design layout data from its head, looks for a program routine corresponding to the root cell (step 1203), and checks whether there is any link to another program routine. When the link is found, the process flies to the link destination, searches the link destination (step 1204), and determines whether the link destination is a cell (step 1205). If the link destination is a cell, the value of the counter will be incremented by unity (step 1206), and it will be checked whether a further link exists. If the link destination is not a cell, the process will return to the link source and will check existence/absence of a further link (step 1204).

After completion of step 1206, whether the further link destination exists is determined (step 1208), and if there is the link destination, the flow will return to step 1204 and will repeat processing of steps 1205 to 1206. Thereby, the reference frequencies of all the cells can be counted for the tree on the hierarchical structure of the cells. Moreover, when the process returns to the cell of the link source at the determination step of step 1205, it means returning to a cell one level higher in the hierarchy hierarchically. Therefore, searching another link on the hierarchical level of the link source corresponds to searching another branch tree of the upper cell (step 1204).

In the determination processing in step 1208, if there exists no further link destination, a determination as to whether all the programs of the design layout data are searched is made (step 1209); if it has not been searched already, the process will return to the cell of the link source and will repeat the processing of steps 1204 to 1209. When all the programs of the design layout data have been searched, the analysis of the whole cells is completed, the reference frequency of each cell is stored in the memory 34 being associated with the cell name (or an identifier for distinguishing the cell), and the analysis processing of the design layout data is completed.

The analysis result stored in the memory 34 is transferred to the recipe generation apparatus through the communication network 25, and is referred to by the apparatus operator when performing a generation work of the recipe. Moreover, a program corresponding to a step shown in FIG. 12 is stored in the memory 34, and is executed by the processor 33.

Although the flow explained above is almost the same as that of the processing executed inside the recipe generation apparatus 30 of the first embodiment, it becomes easy for multiple recipe generation apparatuses to share the analysis result of the design layout data among them by separating the recipe generation apparatus and the analysis processing apparatus of the design layout data.

### LIST OF REFERENCE SIGNS

5 Design layout
20 Clean room
21 Optical inspection and measuring apparatus
22 SEM type inspection and measuring apparatus
25 Communication network
26 Defect information server
27 Design data server
30 Recipe generation apparatus
31 Network interface
32 Storage device
33 Processor
34 Memory
35 User interface

1. A recipe generation apparatus that generates a recipe of an inspection apparatus for inspecting a pattern corresponding a plurality of cells using image data obtained by irradiating a light or charged particle beam onto a sample on which the pattern is formed, the recipe generation apparatus comprising:
a storage means for storing design layout data of the pattern;
a processor for executing predetermined arithmetic processing on the design layout data; and
a display for displaying a processed result by the processor,
wherein the processor analyzes a reference relationship between the plurality of cells, and
the display displays a reference frequency between the plurality of cells together with a layout of the pattern.

2. The recipe generation apparatus according to claim 1,
wherein the processor displays a highlighted image of the inspection object pattern together with a layout pattern obtained by image-developing the design layout data on the display.

3. The recipe generation apparatus according to claim 2,
wherein a border line of the inspection object pattern is displayed on the display as the highlighted image.

4. The recipe generation apparatus according to claim 1, having:
a function of making a pattern that corresponds to a cell having a referring or referred relationship with an arbitrary cell with respect to the arbitrary cell designated by a user be displayed highlighted.

5. The recipe generation apparatus according to claim 1,
wherein the processor executes processing of extracting a cell corresponding to a pattern that contains an arbitrary area on a layout pattern inside, and
the layout pattern is obtained by image-developing the design layout data.

6. The recipe generation apparatus according to claim 5,
wherein extraction processing of the cell is performed by referring to position information of the arbitrary area and position information of the cell.

7. The recipe generation apparatus according to claim 1,
wherein a setup screen for setting up inspection conditions in the inspection apparatus is displayed on the display, and
wherein identification information of the cell and a reference frequency on the basis of a root cell of the cell are displayed on the setup screen.

8. An inspection support apparatus used in relation to an inspection apparatus for inspecting a pattern corresponding to a plurality of cells using image data obtained by irradiating a light or charged particle beam onto a sample on which the pattern is formed, the inspection support apparatus comprising:
a storage means for storing design layout data of the pattern;
a processor for executing predetermined arithmetic processing on the design layout data; and
a display for displaying a processed result by the processor,
wherein the processor analyzes a reference relationship between the plurality of cells, and
the display displays a reference frequency between the plurality of cells together with a layout of the pattern.

9. An inspection system configured by including at least an inspection apparatus for inspecting a pattern corresponding to a plurality of cells using image data obtained by irradiating a light or charge particle beam onto a sample on which the pattern is formed, a recipe generation apparatus for generating an inspection recipe of the inspection apparatus, and a display,
wherein the recipe generation apparatus includes:
a storage means for storing design layout data of the pattern; and
a processor for performing predetermined data arithmetic processing on the design layout data,
wherein the inspection apparatus includes:
an input part for acquiring the inspection recipe generated by the recipe generation apparatus,
wherein the processor analyzes a reference relationship between the plurality of cells, and
the display displays a reference frequency between the plurality of cells together with a layout of the pattern.

10. A recording medium which stores a program to be executed in a recipe generation apparatus that generates an inspection recipe of an inspection apparatus for inspecting a pattern corresponding to a plurality of cells using image data obtained by irradiating a light or charged particle beam onto a sample on which the pattern is formed, the recipe generation apparatus including memory, a processor and a display,
wherein a physical arrangement of a pattern corresponding to an arbitrary cell among the plurality of cells on the sample is obtained by making the processor execute the following processing:
processing of detecting a cell contained in the design layout data;
processing of finding a hierarchical relationship between the detected cells by detecting links between the cells;
processing of finding a number of cells to which a certain cell refers by counting the number of links between the cells; and
processing of instructing to the display for displaying the number of cells referred by the certain cell together with a layout of the pattern.

11. The recording medium according to claim 10,
wherein the program includes processing of displaying a border line of the pattern whose physical arrangement is obtained together with a pattern image obtained by image-developing the design layout data on the display.

12. The recording medium according to claim 11,
wherein the program includes processing of displaying a setup screen for setting an inspection area in the inspection apparatus on a display, and processing in which a user of the recipe generation apparatus specifies the arbitrary cell on the setup screen.

13. (canceled)
